(19) United States
(12) Patent Application Publication
(10) Pub. No.: US 2024/0330945 A1
(43) Pub. Date: Oct. 3, 2024

(54) CHAT SUPPORT PLATFORM HAVING USER-ENABLED CHAT HELP CUSTOMIZATION

(71) Applicant: Truist Bank, Charlotte, NC (US)

(72) Inventor: Barath Jayaraman, Charlotte, NC (US)

(21) Appl. No.: 18/192,619

(22) Filed: Mar. 29, 2023

(51) Int. Cl. G06Q 30/015; G06F 9/451

(52) U.S. Cl. CPC G06Q 30/015; G06F 9/453

(57) ABSTRACT

A computing device, a computer program product, and a computer-implemented method for delivering enhanced financial services and, more particularly, for facilitating a virtual chat communication session between a user and a virtual support agent which facilitates user-enabled chat help customization that enables the user to set and store the type of response to be presented by a virtual support agent in response to a user command or request for help or assistance during virtual chat communication sessions.

### TECHNICAL FIELD

The present disclosure relates to a computing device, computer program product, and computer-implemented method for delivering digital financial services and, more particularly, for a virtual chat communication platform that facilitates user-enabled chat help customization.

### BACKGROUND

Financial institutions that provide financial services are increasingly providing a greater number of client services. In order to alleviate call and chat density from customers over a network environment, such client services include automated virtual support agents (e.g., chatbots) who supplement human virtual support agents by directly interacting with customers via text chat, phone, instant messaging, etc.

### SUMMARY

The present disclosure relates to a computing device, a computer program product, and a computer-implemented method for delivering enhanced digital financial services over a communication network by providing a digital financial management platform for a client device that includes a virtual chat communication platform that facilitates user-enabled chat help customization that enables a user to set and store the type of response to be presented by a virtual support agent in response to a user command or request for help or assistance during virtual chat communication sessions (e.g., both present and future).

In accordance with one or more embodiments set forth, illustrated and described herein, an apparatus may comprise one or more processors; and a non-transitory memory including a set of instructions of computer-executable program code, which when executed by the one or more processors, causes the apparatus to, receive, from a client device of a user during a virtual chat communication session between a virtual support agent of a financial institution on a first chat interface visually displayed on a user interface of the client device of a user executing a mobile application or desktop application associated with the financial institution over a communication network, a command to set a default help setting to a help type; set, in response to receiving the command and contemporaneously with the virtual chat communication session, the default help setting to the help type; and cause, in response to a help request from the user in the virtual chat communication session and contemporaneously with the virtual chat communication session, initiation of a help operation on the virtual chat communication session based on the default help setting.

In accordance with the apparatus, the set of instructions, which when executed by the one or more processors, causes generation of a link for visual display on the user interface of the client device, generation of text instructions for visual display on the user interface of the client device, and initiating an interactive chat help operation.

In accordance with the apparatus, the set of instructions, which when executed by the one or more processors, causes the link to point to a website associated with the financial institution.

In accordance with the apparatus, the set of instructions, which when executed by the one or more processors, causes the set of instructions, which when executed by the one or more processors, causes the apparatus to initiate the interactive chat help operation by initiating an interactive chat help operation with the virtual support agent.

In accordance with the apparatus, the set of instructions, which when executed by the one or more processors, enables the help request to comprise a subject and the help operation is based upon the subject.

In accordance with the apparatus, the set of instructions, which when executed by the one or more processors, causes the default help setting to apply to all further virtual chat communication sessions with the user.

In accordance with the apparatus, the set of instructions, which when executed by the one or more processors, causes the default help setting to apply only to the virtual chat communication session.

In accordance with one or more embodiments set forth, illustrated and described herein, a computer program product comprising at least one non-transitory computer readable medium having with a set of instructions of computer-executable program code, which when executed by one or more processors of a computing device, causes the computing device to, receive, from a client device of a user during a virtual chat communication session between a virtual support agent of a financial institution on a first chat interface visually displayed on a user interface of the client device of a user executing a mobile application or desktop application associated with the financial institution over a communication network, a command to set a default help setting to a help type; set, in response to receiving the command and contemporaneously with the virtual chat communication session, the default help setting to the help type; and cause, in response to a help request from the user in the virtual chat communication session and contemporaneously with the virtual chat communication session, initiation of a help operation on the virtual chat communication session based on the default help setting.

In accordance with the computer program product, the set of instructions, which when executed by the one or more processors, causes the computing device to initiate, contemporaneously with the virtual chat communication session, the help operation by executing one or more of: generate a link for visual display on the user interface of the client device, generate text instructions for visual display on the user interface of the client device, and initiate an interactive chat help operation.

In accordance with the computer program product, the set of instructions, which when executed by the one or more processors, causes the link to point to a website associated with the financial institution.

In accordance with the computer program product, the set of instructions, which when executed by the one or more processors, contemporaneously with the virtual chat communication session, the initiating the interactive chat help operation by initiating an interactive chat help operation with the virtual support agent.

In accordance with the computer program product, the set of instructions, which when executed by the one or more processors, enables the help request to comprise a subject and the help operation is based upon the subject.

In accordance with the computer program product, the set of instructions, which when executed by the one or more processors, causes the computing device to cause, the default help setting to apply to all further virtual chat communication sessions with the user.

In accordance with the computer program product, the set of instructions, which when executed by the one or more processors, causes the computing device to cause, the default help setting to apply only to the virtual chat communication session.

In accordance with one or more embodiments illustrated, set forth, and described herein, a computer implemented method may comprise receiving, by one or more financial institution servers associated with a financial institution during a virtual chat communication session between a virtual support agent of a financial institution on a chat interface visually displayed on a user interface of a client device of a user executing a mobile application or desktop application associated with the financial institution over a communication network, a command to set a default help setting to a help type; setting, by the one or more financial institution servers, in response to the command and contemporaneously with the virtual chat communication session, the default help setting to the help type; and causing, by the one or more financial institution servers, in response to a help request from the user from the virtual chat communication session and contemporaneously with the virtual chat communication session, initiation of a help operation on the virtual chat communication session based upon the default help setting.

In accordance with each respective computer implemented method, further comprising, executing, by the one or more financial institution servers, contemporaneously with the virtual chat communication session, one or more of: generation of a link for visual display on the virtual chat communication session; generation of text instructions for visual display on the virtual chat communication session; initiating an interactive chat help operation on the virtual chat communication session.

In accordance with each respective computer implemented method, further comprising, causing, by the one or more financial institution servers, the link pointing to a website associated with the financial institution.

In accordance with each respective computer implemented method, further comprising, causing, by the one or more financial institution servers contemporaneously with the virtual chat communication session, the initiating the interactive chat help operation by initiating an interactive chat help operation with the virtual support agent.

In accordance with each respective computer implemented method, further comprising, enabling, by the one or more financial institution servers, the help request to comprise a subject and the help operation is based upon the subject.

In accordance with each respective computer implemented method, further comprising, causing, by the one or more financial institution servers, the default help setting to apply to all further virtual chat communication sessions with the user.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the first client device of FIG. 1.

FIG. 3 illustrates a block diagram of the second client device of FIG. 1.

FIG. 4 illustrates a block diagram of the one or more financial institution servers of FIG. 1.

FIG. 5 illustrates a computer-implemented method for implementing a chat communication session with a virtual support agent, in accordance with one or more embodiments set forth and described herein.

FIG. 6 illustrates a computer-implemented method for implementing a chat communication session with a human virtual support agent, in accordance with one or more embodiments set forth and described herein.

FIG. 7 illustrates a virtual chat communication session between a user and a virtual support agent, in accordance with one or more embodiments set forth and described herein.

FIG. 8 illustrates a virtual chat communication session between a user and a virtual support agent with a user setting a default help type to link and a virtual support agent's response, in accordance with one or more embodiments set forth and described herein.

FIG. 9 illustrates a virtual chat communication session between a user and a virtual support agent with a user setting a default help type to instructions and a virtual support agent's response, in accordance with one or more embodiments set forth and described herein.

FIGS. 10 and 11 illustrates a virtual chat communication session between a user and a virtual support agent with a user setting a default help type to interactive help and a virtual support agent's response, in accordance with one or more embodiments set forth and described herein.

FIG. 12 illustrates a computer-implemented method for setting a default help type and a response by the virtual support agent, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code executing on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

In accordance with one or more embodiments set forth, illustrated, and described herein, a virtual chat communication platform is provided for a client device of a user having one or more financial accounts residing at one or more financial institution servers of a financial institution. The virtual chat communication platform enables a single user, using a single client device, to participate in multiple simultaneous virtual chat communication sessions with virtual support agents acting on behalf of the financial institution in support of serving the needs of the user. In that way, the user is not forced to cancel or end a first virtual chat communication session in order to commence two or more additional virtual chat communication sessions using the same client device.

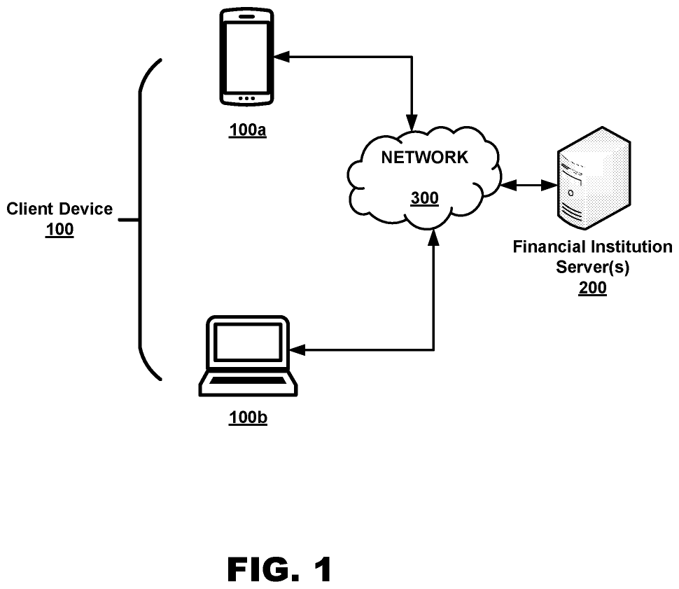

Turning to the figures, in which FIG. 1 illustrates a communication environment that facilitates communications between a user and a financial institution. A client device 100 of a user (financial account holder) operating in the communication environment facilitates user access to and user management of one or more financial accounts residing at one or more financial institution servers 200 of the financial institution. The communication environment includes the client device 100, the one or more financial institution servers 200, and a communication network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

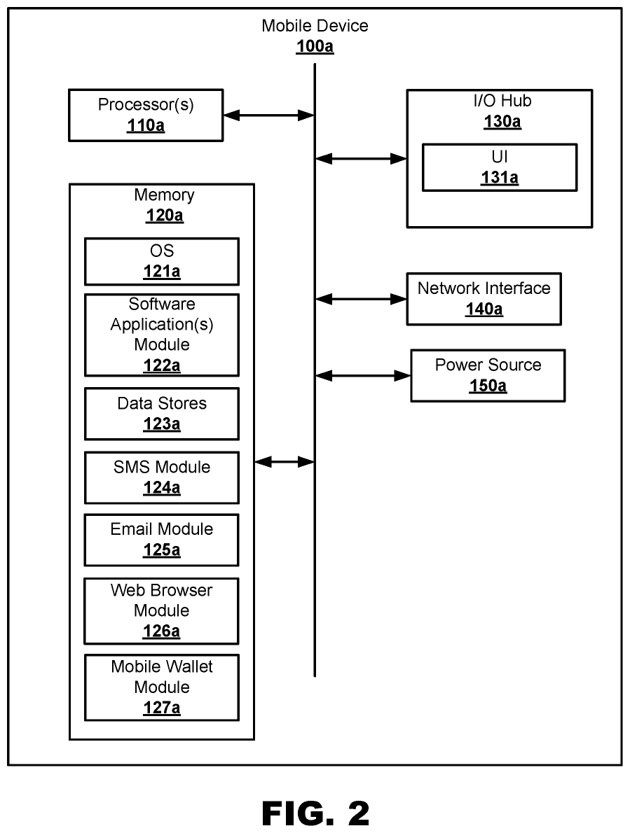

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause execution of an operating system 121a and one or more software applications of a software application module 122a that reside in the memory 120a. The one or more software applications residing in the memory 120a includes, but is not limited to, a financial institution application that is associated with the financial institution. The financial institution application comprises a mobile application or desktop application that facilitates establishment of a secure connection between the mobile device 100a and the one or more financial institution servers 200. The one or more processors 110a are operable to execute the mobile application or desktop application to facilitate user access to the one or more financial accounts and user management of the one or more financial accounts.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a may be a component of the one or more processors 110a or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, the user may receive text messages from the financial institution that are associated with the user access and the user management of the one or more financial accounts. An email module 125a is operable to facilitate user transmission and receipt of email messages via the mobile device 100a through the network 300. In one example embodiment, the user may receive email messages from the financial institution that are associated with the user access and the user management of the one or more financial accounts. The user may utilize a web browser module 126a that is operable to facilitate user access to one or more websites associated with the financial institution through the network 300. A digital wallet module 127a facilitates the generation of one or more digital wallets associated with the one or more financial accounts.

In accordance with one or more embodiments set forth, described, and/or illustrated herein, the mobile device 100a includes an I/O hub 130a operatively connected to other systems and subsystems of the mobile device 100a. The I/O system 130a may include one or more of an input interface, an output interface, and a network controller to facilitate communications between the mobile device 100a and the one or more financial institution servers 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a also includes a network interface 140a operable to facilitate connection to the network 300. The mobile device 100a further includes a power source 150a that comprises a wired powered source, a wireless power source, a replaceable battery source, or a rechargeable battery source.

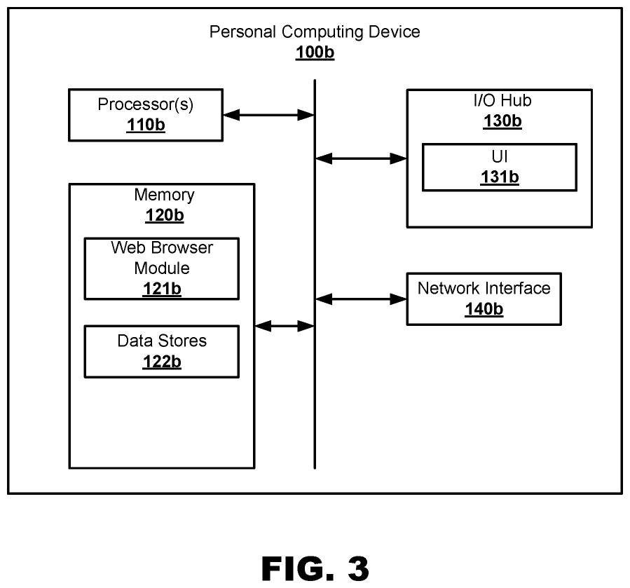

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110A, an I/O hub 130b, and a network interface 140b.

The memory 120b comprises a set of instructions of computer-executable program code. The set of instructions are executable by the one or more processors 110b to cause control of the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122b may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 100b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110b may comprise at least one hardware circuit (e.g., an integrated circuit) operable to carry out instructions contained in program code. In embodiments in which there is a plurality of processors, such processors may work independently from each other, or one or more processors may work in combination with each other.

In accordance with one or more embodiments set forth, described, and/or illustrated herein, the personal computing device 100a includes an I/O hub 130b operatively connected to other systems and subsystems of the personal computing device 100a. The I/O system 130b may include one or more of an input interface, an output interface, and a network controller to facilitate communications between the personal computing device 100a and the one or more financial institution servers 200. The input interface and the output interface may be integrated as a single, unitary user interface 131b, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110b to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The personal computing device 100b also includes a network interface 140b operable to facilitate connection to the network 300.

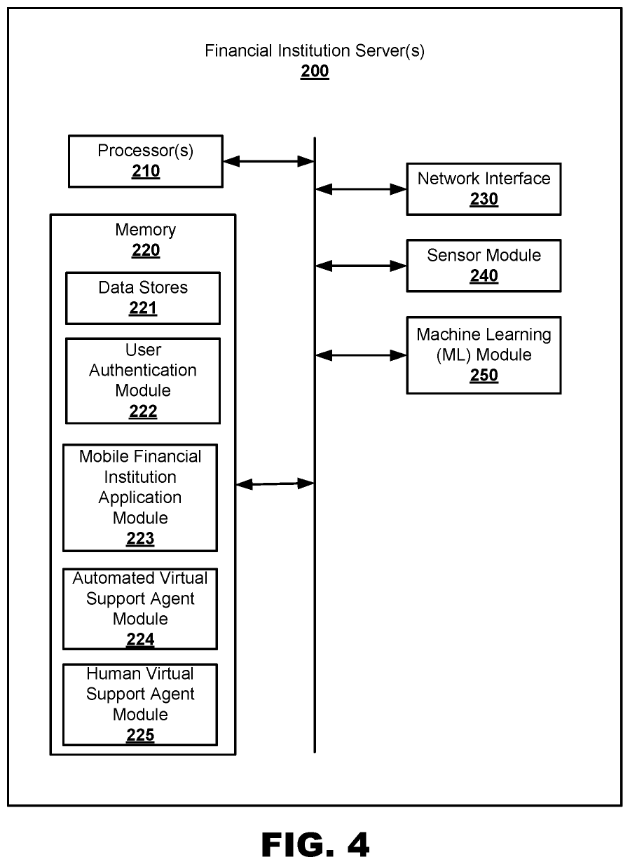

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223 having one or more mobile financial institution applications that reside in the memory 220, an automated virtual support agent module 224, and a human virtual support agent module 225. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the one or more financial institution servers 200 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The memory 220 can store computer readable program code and data which, when executed by the one or more processors 210 (or other processors) can implement (or cause to be implemented) any of the features and methodologies described herein.

The computer-executable program code may instruct the one or more processors 210 to cause the user authentication module 221 to authenticate a user in order to gain user access to the one or more financial accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the first client device 100a and the second client device 100b in a manner which facilitates user access to the one or more financial accounts in addition to user management of the one or more financial accounts based on successful user authentication.

The sensor module 240 is operable, at least during execution of the mobile application or desktop application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more financial accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application or desktop application associated with the financial institution over the communication network 300.

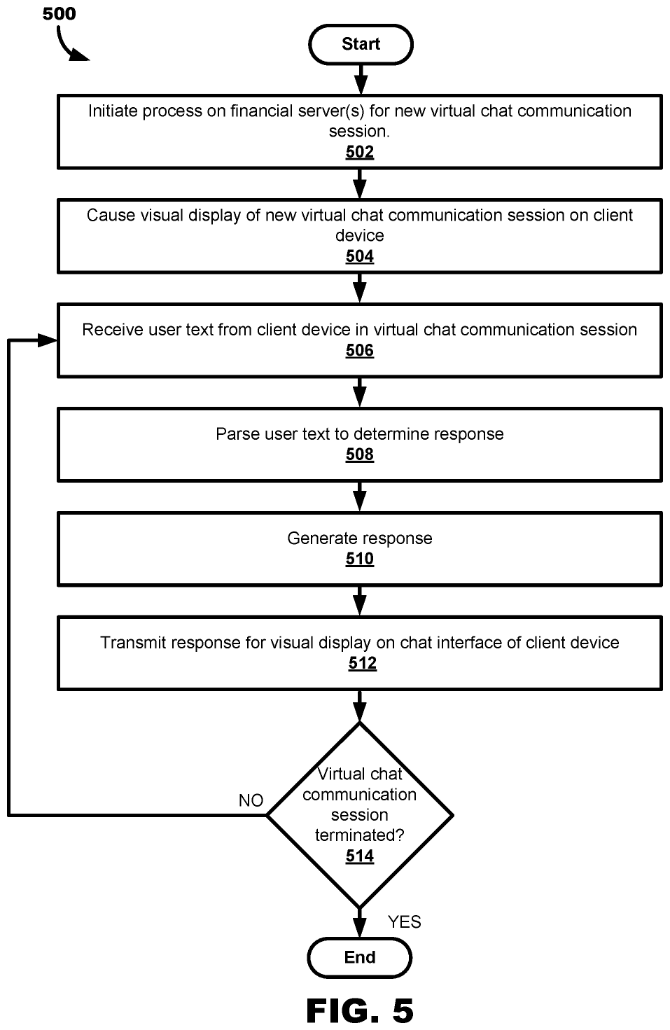

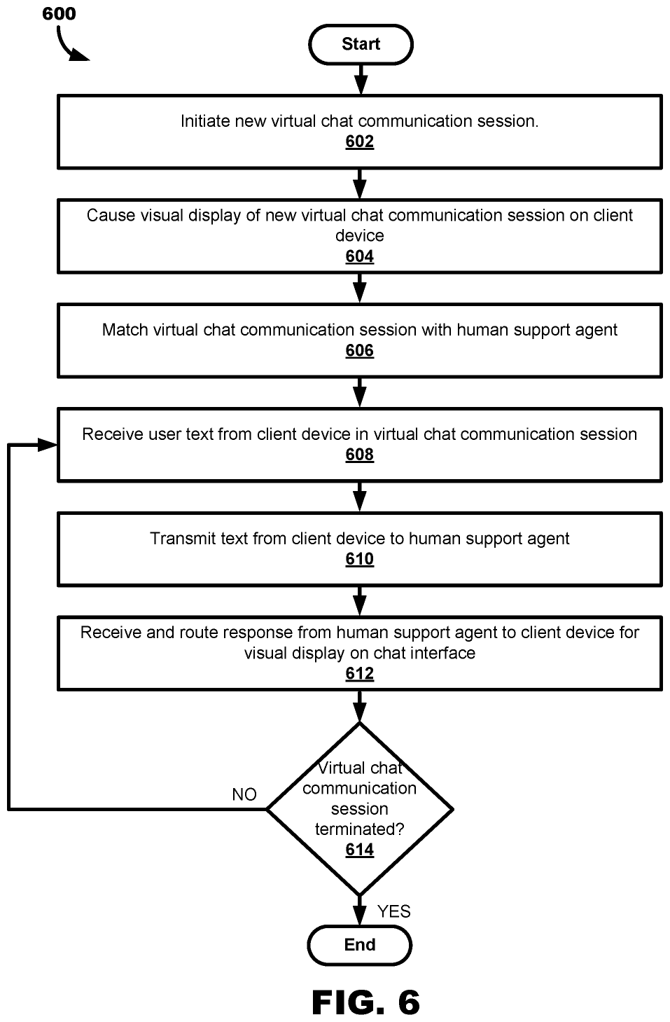

Illustrated examples shown in FIGS. 5 and 6 set forth computer-implemented methods 500 and 600. In one or more examples, the respective flowcharts of the computer-implemented methods 500 and 60 may be implemented by the one or more processors 210 of the one or more financial institution servers 200. In particular, the computer-implemented methods 500 and 600 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 500 and 600 set forth, described, and/or illustrated herein, or provides functionality set forth, described, and/or illustrated.

As illustrated in FIG. 5, a computer-implemented method 500 can implement a virtual chat communication session between a user and an automated virtual support agent, in accordance with one or more embodiments set forth and described herein. Illustrated process block 502 causes the one or more processors 210 to initiate a new dedicated process in order to facilitate a new virtual chat communication session. This initiation may include such operations as allocating memory, adding the new virtual chat communication session to a chat queue (of all virtual chat communication sessions administered by the financial institution server(s) 200), and all other such tasks.

From illustrated process block 502, the computer-implemented method 500 proceeds to illustrated process block 504, which causes a visual display of a new virtual chat communication session on the client device 100 by causing software executing on the client device 100 to display a GUI showing the new virtual chat communication session. A virtual chat communication session can be a stand-alone chat interface comprising a chat window, or a chat window superimposed over a chat widget (discussed further herein) or any GUI which functions to facilitate a virtual chat communication session between a user and a virtual support agent. The one or more processors 210 would communicate with a process executing on the client device 100 so that the process (could be an application program executing on the client device, a web browser, the operating system on the client device 100 itself, etc.) instructs the client device 100 to open the new virtual chat communication session by utilizing a GUI on the interface 131a, 131b of the client device 100.

From illustrated process block 504, the computer-implemented method 500 proceeds to illustrated process block 506, which includes receiving text entered (textual, verbal, etc.) by the user into the GUI on the client device 100.

From illustrated process block 506, the computer-implemented method 500 proceeds to illustrated process block 508, which includes analyzing/processing the text of the user by parsing, e.g., by separating the words contained in the text and analyzing the text using one or more such techniques, such as a rules-based system, a machine learning model (such as a convolution neural network), natural language processing (NLP), text mining, or the like.

From illustrated process block 508, the computer-implemented method 500 proceeds to illustrated process block 510, which includes generating (or determining) a response to the text in response to analyzing/processing the text. The response may be generated using the one or more such techniques, which may include querying a database/storage location in memory 220 to retrieve the response. For example, should the user provide a text query “what is my account balance,” the text analyzer would analyze the text to determine that there is an unknown quantity needed (the user's account balance), and then query the one or more financial institution server(s) 200 to retrieve the quantity needed (the user's account balance).

From illustrated process block 510, the computer-implemented method 500 proceeds to illustrated process block 512, which includes, after generating the response, transmitting the response and causing a visual display thereof (e.g., “Your balance is $1,000.00”) on the chat interface on the user interface 131a, 131b.

From illustrated process block 512, the computer-implemented method 500 proceeds to illustrated decision block 514, which determines whether any event(s) has/have occurred to terminate the virtual chat communication session. A number of events may result in termination of the virtual chat communication session, including, but not limited to, the user closing the chat window on the client device 100, the user communicating (textually and/or verbally) “end this chat” (or some similar phrase), a human virtual support agent manually terminating the virtual chat communication session, the lapse of a predetermined amount of time (e.g., 10 minutes) without receiving any input from the user on the client device 100, the user logging out of the mobile application or desktop application on the client device 100, etc. Note that should no event occur to terminate the virtual chat communication session, then the virtual chat communication session will continue. Should, in illustrated decision block 514, it be determined that the virtual chat communication session is terminated, then the computer-executable program code may instruct the one or more processors 210 to close the virtual chat communication session processes, and the virtual chat communication session would no longer require resources by the financial institution server(s) 200. Should, in illustrated decision block 514, it be determined that the virtual chat communication session has not been terminated, then the computer-implemented method 500 would return to illustrated process block 506.

In accordance with one or more embodiments described herein, a user can engage in multiple virtual chat communication sessions in parallel (i.e., contemporaneously or simultaneously) with different virtual support agents (human or automated) from a financial institution. This can be advantageous because the user may have separate issues to discuss, and while the user is waiting for a response from one virtual support agent, may engage in another virtual chat communication session another virtual support agent to discuss another issue. Executing multiple virtual chat communication sessions in parallel can also be advantageous in that the user can separate different issues into different respective virtual chat communication sessions, avoiding potential confusion of using a single virtual chat communication session to address different issues. Using multiple virtual chat communication sessions can also be advantageous because a user may have one complex issue which requires a human virtual support agent while also having a simple issue which could be addressed by a virtual agent, so utilizing separate virtual chat communication sessions for each (one session with a human virtual support agent and one session with a virtual agent) would preserve resources at the financial institution.

As illustrated in FIG. 6, a computer-implemented method 600 can implement a virtual chat communication session between a user and a human virtual support agent, in accordance with one or more embodiments set forth and described herein. Illustrated process blocks 602 and 604 can be implemented the same as illustrated process blocks 502 and 504, respectively, from FIG. 5.

From illustrated process block 604, the computer-implemented method 600 proceeds to illustrated process block 606, which includes matching the virtual chat communication session for the user with a human virtual support agent associated with the financial institution. The financial institution may have one or more human virtual support agents having access to the financial institution server(s) 200, and whom have their own client device to facilitate communication with the user via a virtual chat communication session. The computer-executable program code may instruct the one or more processors 210 to match the virtual chat communication session with one of the plurality of human virtual support agents. The matching can be executed randomly, or a human virtual support agent can be selected based on certain criteria (e.g., linguistically compatible with a detected language used by the user, specialized knowledge and/or experience in the financial service being requested by the user, etc.)

From illustrated process block 606, the computer-implemented method 600 proceeds to illustrated process block 608, which includes receiving text entered (textual, verbal, etc.) by the user into the GUI on the client device 100.

From illustrated process block 608, the computer-implemented method 600 proceeds to illustrated process block 610, which includes transmitting the text received from the virtual chat communication session (in illustrated process block 608) to the matched human virtual support agent for this respective virtual chat communication session.

From illustrated process block 610, the computer-implemented method 600 proceeds to illustrated process block 612, which includes receiving and transmitting a response (textually or verbally) from the human virtual support agent (the human virtual support agent could first conduct research of data/information stored in memory 220), and then routing the response to the client device 100 for visual display on the user interface 131a, 131b.

From illustrated process block 612, the computer-implemented method 600 proceeds to illustrated decision block 614, which determines whether any event(s) has/have occurred to terminate the virtual chat communication session. This can be done identically to illustrated decision block 614 from FIG. 5. Should it be determined that the virtual chat communication session is terminated, then the chat window visually displayed on the user interface 131a, 131b of the client device 100 is closed (for this particular virtual chat communication session only, any remaining virtual chat communication session would still be active and visually displayed). Should it be determined that the virtual chat communication session is not terminated, the computer-implemented method 600 would return to illustrated process block 608.

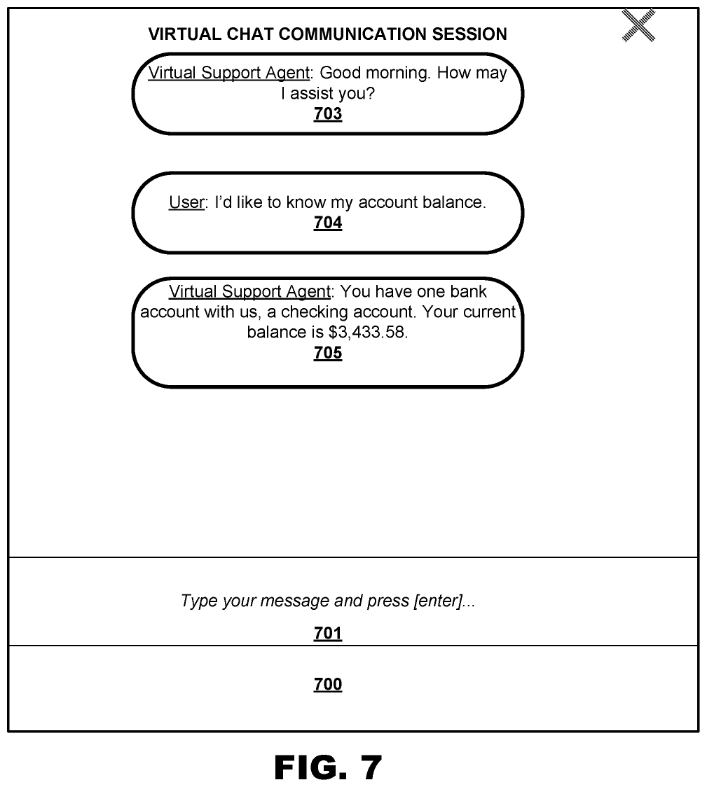

As illustrated in FIG. 7, upon a user launching a financial institution mobile application or desktop application on the client device 100, and being authenticated by the user authentication module 221, the computer-executable program code may instruct the one or more processors 210 to cause a display of a GUI on the user interface 131a, 131b of the client device 100. The GUI comprises a chat interface (e.g., a chat window) 700 that facilitates a virtual chat communication session (e.g., a textual chat or a verbal chat) with a virtual support agent that comprises a plurality of chat messages 703, 704 and 705. A chat box 701 is used for the user to enter chat messages (e.g., queries, commands, etc.) intended for the virtual support agent and also displayed as a chat message above the chat box 701. For example, during the virtual chat communication session, the user may transmit a chat message 704 comprising a general request (verbal or textual) for information. In response to the request/command, the computer-executable program code may instruct the one or more processors 210 to execute analysis or processing (e.g., parsing and/or NLP) of the request/command (chat message 704). This will be executed for all chat messages transmitted by the user via the client device 100. In response to executing or implementing the NLP, the computer-executable program code may instruct the one or more processors 210 to generate a response to the message 704, and then transmit a chat message 705 providing information that was requested by the user. In particular, in response to receipt of the user message 704 for information, the computer-executable program code may instruct the one or more processors 210 to cause a visual display of a chat message 705 on the chat interface visually displayed on the user interface 131a, 131b of the client device 100.

In accordance with one or more embodiments, a command can be entered by a user in the virtual chat communication session. Different users may prefer different types of help responses to be presented by a virtual support agent in response to a user command or request for help or assistance (e.g., making a wire transfer, etc.) on a particular subject during a virtual chat communication session. For example, when asking for a help or assistance on a particular topic, help can be offered by the virtual support agent in different forms: providing a link to a webpage on the web site of the financial institution relevant to the particular subject of the help request; displaying text providing help on the subject right inside the virtual chat communication session; providing an audio file; and initiating an interactive chat help session so that the virtual support agent can obtain all information needed and initiate the transaction right there inside the virtual chat communication session. The user can set a default help response which would apply to further help requests (the default may apply just to requests for the current virtual chat communication session, or the default may apply to all future virtual chat communication sessions involving the user). The user can issue a command to set the default help type (e.g., provide link, provide text, or initiate an interactive chat help session). The command to set the default can take any natural language form, for example “set help type to link”, “provide link as help”, “set default help to link”, or any other similar text phrase which indicates the user is intending to change the default help response along with the desired help response (e.g., “link”). Once the default is set, when a user enters a command in the virtual chat communication session requesting help, the virtual support agent will provide help for the user based on the user setting. For example, should the user enter into the chat box 701 “help with wires,” then the virtual support agent will provide the user in the virtual chat communication session with help with wires (the subject) using the default setting the user had set earlier. The user can request help on any subject the user wishes (e.g., transfers, wires, closing account, etc.) and the help provided by the virtual support agent would be relevant to the requested subject. If the virtual support agent cannot provide help on a particular subject (e.g., a subject of which help is not available”, the virtual support agent would display a message in the virtual chat communication session to the effect that help is not available for that subject.

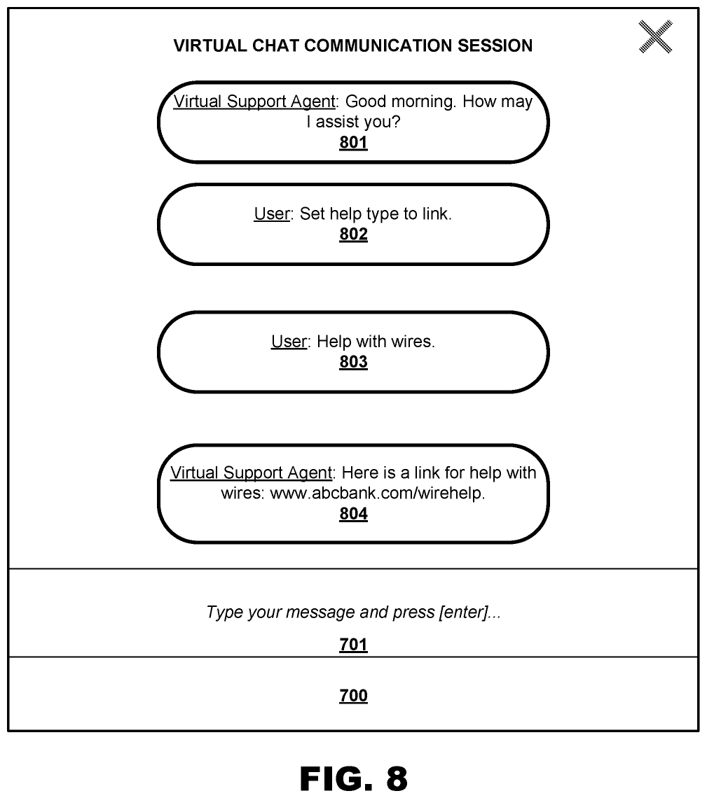

As illustrated in FIG. 8, a virtual chat communication session between a user and a virtual support agent has a user setting a default help type to link and a virtual support agent's response, in accordance with one or more embodiments set forth and described herein. The one or more processors 210 cause a display of the virtual chat communication session 700 on the GUI on the user interface 131a, 131b of the client device 100.

The virtual support agent communicates a chat message 801 which is a general greeting. Thereafter, the user enters (textually or verbally) a command in the chat box 701 which appears as chat message 802 to set the default help type to link. The command can come in any form so long as it can be processed a by a natural language processor which indicates that the user intends to change the default help type setting to a given help type (e.g., “link”, “instructions,” “interactive chat,” and the like).

The user then enters a command for a help request in the chat box 701 for “help with wires” which appears as chat message 803 The help request can come in any form so long as it can be processed by a natural language processor and should include the subject of the help request (should no subject be provided, then the virtual support agent can reply with further instructions on how to properly enter a help request).

In response to executing or implementing the NLP on the help request (chat message 803), the computer-executable program code may instruct the one or more processors 210 to generate a help response and then transmit the response for visual display on the virtual chat communication session as chat message 804. The help response (chat message 804) provides help on the subject in the help request (chat message 803) in the help type set in the command (chat message 802) to set the default help type. In this example, since the default help type was set to “link”, the help response (chat message 804) provides a user-engageable link which links to a webpage on the website of the financial institution administering the web page or application the user is currently viewing. The link can be engaged by the user to thereby cause a web browser (outside of the virtual chat communication session) to be visually displayed in the client device 100 (unless a web browser is already active on the client device 100). The web browser would direct the user to a web page that contains instructions for the user on the subject for which the user requires help and/or assistance. Note that the help provided in the help response (chat message 804) by the virtual support agent has at least two variables: the help type, provided in the command (chat message 802) to set the default help type) and the help subject (provided in the help request (chat message 803).

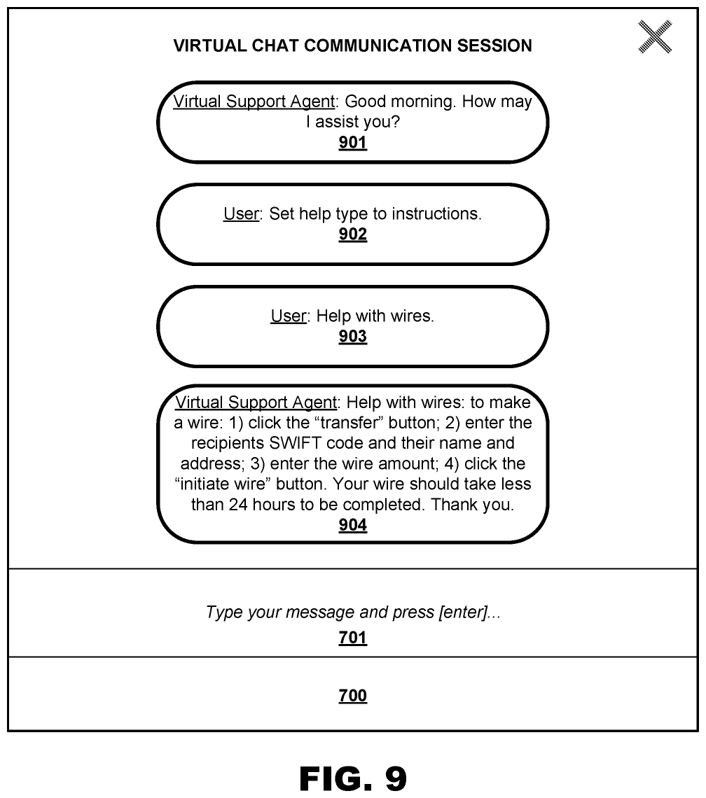

As illustrated in FIG. 9, a virtual chat communication session between a user and a virtual support agent has a user setting a default help type to instructions and a response by a virtual support agent, in accordance with one or more embodiments set forth and described herein. The one or more processors 210 cause a display of the virtual chat communication session 700 on the GUI on the user interface 131a, 131b of the client device 100. The virtual support agent communicates chat message 901 (a general greeting).

Thereafter, the user enters a command (in the chat box 701) to set the default help type to instructions which appears as chat message 902. The user then enters a help request in the chat box 701 for help with wires, which appears as chat message 903.

In response to executing or implementing the NLP on the help request (chat message 903), the computer-executable program code may instruct the one or more processors 210 to generate a help response (chat message 904) and then transmit the response for visual display on the chat interface. In contrast to providing an indirect display of instructions (i.e., via a web link, illustrated in FIG. 8, chat message 804), the virtual support agent for this help type directly displays the help response (chat message 904) which visually displays the instruction text directly inside the chat interface. Thus, for the help type “instructions” no web browser needs to be opened and the help instructions are conveniently displayed within the virtual chat communication session.

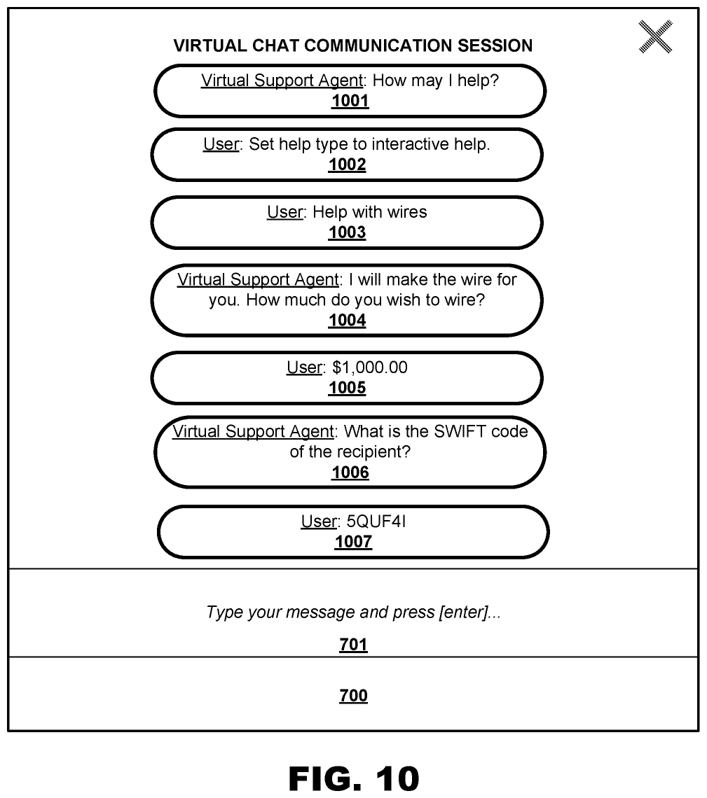

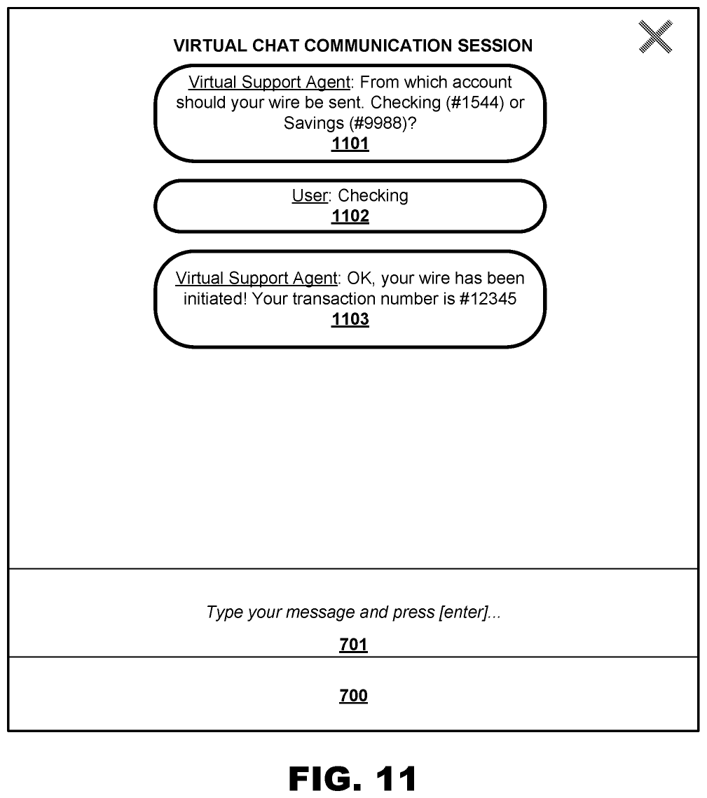

As illustrated in FIGS. 10 and 11, a virtual chat communication session between a user and a virtual support agent has a user setting a default help type to interactive chat help and a virtual support agent's response, in accordance with one or more embodiments set forth and described herein. The one or more processors 210 cause a display of the virtual chat communication session 700 on the GUI on the user interface 131a, 131b of the client device 100. The virtual support agent communicates a chat message 1001 (a general greeting).

Thereafter, the user enters a command in the chat box 701 (chat message 1002) to set the default help type to interactive chat help (or interactive help, interactive chat session, interactive chat help operation, etc.)

Then user enters a help request in the chat box 701 (which appears as chat message 1003) for help or assistance with wires.

In response to executing or implementing the NLP on the help request (chat message 1003), the computer-executable program code may instruct the one or more processors 210 to initiate a visually interactive chat help session in which the virtual support agent will then display a set of questions and ask for responses. When the virtual support agent has all of the needed information, the virtual support agent can then initiate the transaction from within the virtual chat communication session without the user having to utilize a different portion of the financial institution's web site or app to complete the transaction.

The dialogue between the user and the virtual support agent that comprises a series of questions from the virtual support agent and responses from the user. In the illustrated examples of FIGS. 10 and 11, the virtual support agent would ask a first question (chat message 1004), and receive a first user response to the question (chat message 1005) from the client device 100. The virtual support agent would then ask a second question (chat message 1006), and receive a second user response to the question (chat message 1007). The virtual support agent would then ask a third question (chat message 1101), and receive a third user response to the question (chat message 1102).

Through the series of questions and answers, the virtual support agent has acquired all of the necessary information needed to complete the transaction. The transaction can then be initiated by the one or more financial institution servers 200 from within the virtual chat communication session without the user having to navigate outside of the virtual chat communication session in order to initiate/execute/complete the transaction. A confirmation that the transaction has been initiated/executed/completed is generated and transmitted for visual display (chat message 1103) on the client device 100. Additional information evidencing the transaction (e.g., a transaction number, etc.) can also be generated and visually displayed as a chat message.

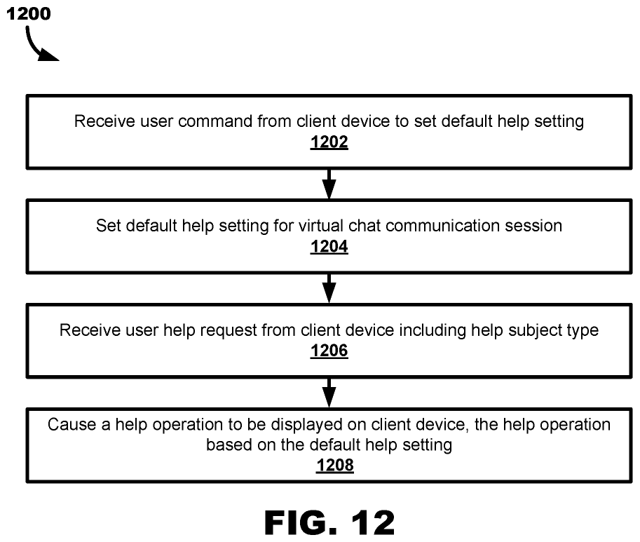

Illustrated example in FIG. 12 sets forth a computer-implemented method 1200. In one or more examples, the respective flowcharts of the computer-implemented method 1200 may be implemented by the one or more processors 210 of the one or more financial institution servers 200. In particular, the computer-implemented method 1200 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. It is noted that the computer-implemented methods 1100, 1200 are typically entirely implemented electronically without the need for a human agent.

FIG. 12 illustrates a computer-implemented method 1200 for setting a default help type and a response by the virtual support agent, in accordance with one or more embodiments set forth and described herein.

In illustrated process block 1202, during a virtual chat communication session on the client device 100, a user command is received/acquired to set a default help setting. The command can come in any textual form and can be processed through a natural language processor in order to identify and parse the command. There is no exact format the command needs to be in. For example, all of the following are valid commands to set the default help setting, “set help type to link”, “set default help type to instructions”, “set default help link”, “default help is interactive session”, etc.

The computer-implemented method 1200 can proceed to illustrated process block 1204, which sets the default help type for the virtual chat communication session to the help type the user specified in illustrated process block 1202. In an embodiment, the default help setting can be applied to all further virtual chat communication sessions involving the user's account. The virtual chat communication session can have a configuration file which stores settings for the virtual chat communication session, which would include the default help type.

The computer-implemented method 1200 can proceed to illustrated process block 1206, which receives/acquires a help request from the user in the virtual chat communication session. The help request would include a subject which is the type of help the user is requesting (e.g., wires, transfers, closing an account, etc.)

The computer-implemented method 1200 can then proceed to illustrated process block 1208, which causes a help operation to be visually displayed in the virtual chat communication session on the client device 100. The help that is displayed would be in a format based on the help type set in illustrated process block 1204. The help displayed would also be pertaining to the subject of the help request set forth in illustrated process block 1206. The one or more financial institution servers 200 would store one or more sets of help information for each subject, the sets of help information corresponding to each help type in a database/storage location associated with the one or more financial institution servers 200. For example, should there be three type/categories (e.g., link, instruction, and interactive chat) and five help subjects (e.g., wires, transfers, closing account, change password, and dispute transaction) then the database/storage location can store 15 files of unique help operations, one for each combination of help type and help subject. The files can contain the information and/or data that will be visually displayed. In the case of an interactive chat help operation, the file can contain identifiers of all of the fields needed from the user, and instructions on how to initiate the transaction one all of the needed information has been obtained from the user in the virtual chat communication session. To fulfill a help request, the respective help file based on the default help type and the help subject can be retrieved and visually displayed (or in the case of an interactive chat help operation, initiated) on the client device 100.

In accordance with one or more embodiments set forth, described, and/or illustrated herein, the client device 100 and the one or more financial institution servers 200 could function in a fully virtualized environment. A virtual machine is where all hardware is virtual and the operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software executing on hardware platform, and one or more virtual machines executing on hardware platform by way of virtualization software. Virtualization software is therefore logically interposed between the physical hardware of hardware platform and guest system software executing “in” virtual machine.

Memory of the hardware platform may store virtualization software and guest system software executing in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, causes the apparatus to:
receive, from a client device of a user during a virtual chat communication session between a virtual support agent of a financial institution on a first chat interface visually displayed on a user interface of the client device of a user executing a mobile application or desktop application associated with the financial institution over a communication network, a command to set a default help setting to a help type;
set, in response to receiving the command and contemporaneously with the virtual chat communication session, the default help setting to the help type; and
cause, in response to a help request from the user in the virtual chat communication session and contemporaneously with the virtual chat communication session, initiation of a help operation on the virtual chat communication session based on the default help setting.

2. The apparatus of claim 1, wherein the set of instructions, which when executed by the one or more processors, causes the apparatus to initiate the help operation by executing one or more of:
generation of a link for visual display on the user interface of the client device,
generation of text instructions for visual display on the user interface of the client device, and
initiating an interactive chat help operation.

3. The apparatus of claim 2, wherein the link directs the user to a website associated with the financial institution.

4. The apparatus of claim 2, wherein the set of instructions, which when executed by the one or more processors, causes the apparatus to initiate the interactive chat help operation by initiating an interactive chat help operation with the virtual support agent.

5. The apparatus of claim 1, wherein the set of instructions, which when executed by the one or more processors, enables the help request to comprise a subject and the help operation is based upon the subject.

6. The apparatus of claim 1, wherein the set of instructions, which when executed by the one or more processors, causes the default help setting to apply to all further virtual chat communication sessions with the user.

7. The apparatus of claim 1, wherein the set of instructions, which when executed by the one or more processors, causes the default help setting to apply only to the virtual chat communication session.

8. A computer program product comprising at least one non-transitory computer readable medium having with a set of instructions of computer-executable program code, which when executed by one or more processors of a computing device, causes the computing device to:
receive, from a client device of a user during a virtual chat communication session between a virtual support agent of a financial institution on a first chat interface visually displayed on a user interface of the client device of a user executing a mobile application or desktop application associated with the financial institution over a communication network, a command to set a default help setting to a help type;
set, in response to receiving the command and contemporaneously with the virtual chat communication session, the default help setting to the help type; and
cause, in response to a help request from the user in the virtual chat communication session and contemporaneously with the virtual chat communication session, initiation of a help operation on the virtual chat communication session based on the default help setting.

9. The computer program product of claim 8, wherein the set of instructions, which when executed by the one or more processors, causes the computing device to initiate, contemporaneously with the virtual chat communication session, the help operation by executing one or more of:
generate a link for visual display on the user interface of the client device,
generate text instructions for visual display on the user interface of the client device, and
initiate an interactive chat help operation.

10. The computer program product of claim 9, wherein the set of instructions, which when executed by the one or more processors, causes the link to point to a website associated with the financial institution.

11. The computer program product of claim 9, wherein the set of instructions, which when executed by the one or more processors, causes the computing device to cause, contemporaneously with the virtual chat communication session, the initiate the interactive chat help operation by initiating an interactive chat help operation with the virtual support agent.

12. The computer program product of claim 8, wherein the set of instructions, which when executed by the one or more processors, enables the help request to comprise a subject and the help operation is based upon the subject.

13. The computer program product of claim 8, wherein the set of instructions, which when executed by the one or more processors, causes the computing device to cause the default help setting to apply to all further virtual chat communication sessions with the user.

14. The computer program product of claim 8, wherein the set of instructions, which when executed by the one or more processors, causes the computing device to cause the default help setting to apply only to the virtual chat communication session.

15. A computer implemented method, comprising:
receiving, by one or more financial institution servers associated with a financial institution during a virtual chat communication session between a virtual support agent of a financial institution on a chat interface visually displayed on a user interface of a client device of a user executing a mobile application or desktop application associated with the financial institution over a communication network, a command to set a default help setting to a help type;
setting, by the one or more financial institution servers, in response to the command and contemporaneously with the virtual chat communication session, the default help setting to the help type; and
causing, by the one or more financial institution servers, in response to a help request from the user from the virtual chat communication session and contemporaneously with the virtual chat communication session, initiation of a help operation on the virtual chat communication session based upon the default help setting.

16. The computer implemented method of claim 15, further comprising, executing, by the one or more financial institution servers, contemporaneously with the virtual chat communication session, one or more of:
generation of a link for visual display on the virtual chat communication session;
generation of text instructions for visual display on the virtual chat communication session;
initiating an interactive chat help operation on the virtual chat communication session.

17. The computer implemented method of claim 16, further comprising, causing, by the one or more financial institution servers, the link pointing to a website associated with the financial institution.

18. The computer implemented method of claim 16, further comprising, causing, by the one or more financial institution servers contemporaneously with the virtual chat communication session, the initiating the interactive chat help operation by initiating an interactive chat help operation with the virtual support agent.

19. The computer implemented method of claim 15, further comprising, enabling, by the one or more financial institution servers, the help request to comprise a subject and the help operation is based upon the subject.

20. The computer implemented method of claim 15, further comprising, causing, by the one or more financial institution servers, the default help setting to apply to all further virtual chat communication sessions with the user.
